(19) United States
(12) Patent Application Publication
(10) Pub. No.: US 2014/0087908 A1
(43) Pub. Date: Mar. 27, 2014

(54) OIL TRAP RING DISK FOR A PLANET WHEEL CARRIER

(71) Applicants: Tomas Smetana, Herzogenaurach (DE); Ramon Jurjanz, Erlangen (DE)

(72) Inventors: Tomas Smetana, Herzogenaurach (DE); Ramon Jurjanz, Erlangen (DE)

(73) Assignee: SCHAEFFLER TECHNOLOGIES AG & CO. KG, Herzogenaurach (DE)

(21) Appl. No.: 14/115,262

(22) PCT Filed: Apr. 19, 2012
(86) PCT No.: PCT/EP2012/057147

§ 371 Date: Dec. 11, 2013

(30) Foreign Application Priority Data
May 3, 2011 (DE) 102011075166.1

(51) Int. Cl. F16H 57/04

(52) U.S. Cl. CPC F16H 57/0427
USPC 475/159

(57) ABSTRACT

An oil retaining plate for attachment to a planetary gear carrier. The oil retaining plate forms an annular pocket that is open toward the planetary gear carrier and has base wall sections that bulge radially outward to the radial level of the planetary gear axes of the planetary gear carrier.

### CROSS-REFERENCE TO RELATED APPLICATIONS

The present application is the U.S. national stage application pursuant to 35 U.S.C. §371 of International Application No. PCT/EP2012/057147, filed Apr. 19, 2012, which application claims priority of German Application No. 102011075166.1, filed May 3, 2011.

### FIELD OF THE INVENTION

The invention relates to an oil retaining plate for a planetary gear carrier, having a base body designed with an annular shape and having an inner boundary area, the same thereby bordering a central opening, where the base body forms a circular recess in an area which borders on the radial outside of the central opening, the circular recess functioning to capture lubricant from the region of the central opening.

### BACKGROUND OF THE INVENTION

A planetary gear carrier arrangement is known from German Patent No. 195 34 791 A1 which is configured with an oil retaining plate, the same accordingly being made of a flat material and placed on the end face of a planetary gear carrier. This oil retaining plate has a central opening. This central opening is bounded by a circular recess, where lubricant can be captured by the same. The captured lubricant is fed to channels, which are formed in the end face of the planetary gear carrier and are covered by the oil retaining plate. The lubricant travels via these channels formed in the planetary gear carrier to planetary gear axles, which are anchored in the planetary gear carrier.

A planetary gear carrier is likewise known from German Patent Application No. 10 2005 054 084 A1, having an oil retaining plate. This oil retaining plate forms a channeled profile with an opening facing the axis of the planetary gear carrier. Oil feed taps are molded onto the channeled profile on the side of the oil retaining plate which faces the planetary gear carrier, where these oil feed taps thereby form oil feed channels via which the oil captured by the channeled profile can be routed to the region of the hearing pins of the planetary gear carrier.

### BRIEF SUMMARY OF THE INVENTION

The present invention provides solutions which make it possible to create an oil retaining structure for a planetary gear carrier which can be manufactured in an advantageous manner—as far as manufacturing processes are concerned—and which has a sufficiently robust construction, where the oil retaining structure ensures an efficient supply of lubricant in the region of the planetary gear axles.

The invention by an oil retaining plate made to be placed on a planetary gear carrier, having an annular body with an outer edge; a seat where the annular body sits on the planetary gear carrier; a central opening which is bordered by an inner edge; a circular recess which extends around the central opening along a circular region between the seat and the inner edge, and which rises axially above the seat to form an access slot which runs between the inner edge and the end face of the planetary gear carrier, to capture lubricant which then as such travels to the region of the central opening; where the circular recess has recess segments which bulge outward radially and which extend outward from the inner edge which borders the central opening, as far as the radial distance of the planetary gear axles of the planetary gear carrier, where the recess segments are arranged sequentially along the periphery of the base area of the circular recess, the base area facing away from the central opening and abutting the seat; and where the circular recess is open to the planetary gear carrier in the lateral region of the circular recess which faces the planetary gear carrier, and is accordingly bounded by the planetary gear carrier itself.

As a result, it is possible to create an oil retaining plate structure having a low axial constructed height, where it is possible to achieve a supply of lubricating oil to the planetary gear axles in a particularly effective and reliable manner by means of the oil retaining structure. The bulges of the circular recess in this case function as oil feed channels, as well as funnels and storage structures.

The oil retaining plate supports the lubrication of the planetary gear sets in highly compact planetary drives for high rotation speed electric drive systems. If the corresponding drive has multiple stages, and also a differential gearbox, an oil retaining plate can be placed on each rotating planetary gear carrier.

The oil retaining plate can be designed in such a manner that it enables the lubrication of the planetary gear axles of a multi-component spur gear differential—that is, a spur gear differential having four planetary gear pairs. For this purpose, the positioning of the circular recess segments, which bulge outward radially is such that the zones of the circular recess segments, which bulge out the most radially correspond to the axes of the planetary gears. As a result, a double pouch, which is composed of two circular recess segments is functionally assigned to each planetary gear pair. There is a connection space between each pair of pouches arranged adjacent along the periphery, the connection space having a base wall which bows inward radially—meaning with a convex curve toward the axis of rotation.

In an embodiment of the invention, the base body is sized in such a manner that the outer edge rises above the shell diameter of the planetary gears carried by the planetary gear carrier. As a result, it is possible for the edge region of the oil retaining plate to dip into the oil pan of a corresponding gear device, and thus, for lubricant to be captured via the circular recess. The oil retaining plate has an edge walling on its outside edge region, for example.

As a result of this edge walling, the scoop function of the oil retaining plate is increased, and also the edge region is made more rigid. The edge walling in this case is designed in such a manner that it extends continuously along the outer edge. Channel holes can be formed into the edge walling. The oil captured by the inner region of the edge walls can be centrifuged out in a defined manner through these channel holes. It is also possible for the edge walling to be configured with other geometries, where the oil capturing properties are determined by the geometries. As such, it is possible, by way of example, to capture larger oil volumes, if the edge walling forms multiple scoop walls in sequence around the periphery, which dip into the oil pan at a shallow approach angle, and displace the captured oil inward radially, and optionally cause the same to penetrate into the region of the central opening via interaction with other surrounding geometries. The transport of oil into the region of the central opening can be realized in this case on the basis of different transport principles. At low rotation speeds, the captured oil is initially raised out of the pan, and can then flow down onto the oil retaining plate and drip into the region of the central opening. At higher speeds, the captured oil is centrifuged into the region surrounding the oil retaining plate, and for example, is conveyed by surrounding structures at least partially into the region of the central opening. Further surface structures, for example, channel structures, can be constructed in the front side of the oil retaining plate which faces away from the planetary gear carrier, resulting in a definitive transport of oil toward the central opening via the surface structures as a result of the viscosity, the inertia, and the wetting ability of the lubricant.

In another embodiment of the invention, channel pins are formed in the region of the recess segments, project axially beyond the seat of the base body, and when assembled dip into the bearing pins of the planetary gears. The channel pins can be sized in such a manner that they dip into the bearing pins while forming a manner of press-fit, thus, contributing to the securement of the oil retaining plate on the planetary gear carrier. Locking means can be formed on the channel pins, engaging with a complementary structure of the bearing pins, for example a rectangular groove. The channel pins are oriented such that the openings thereof face inward radially. The channel bases transition into the bulging base region of the respective circular recess segment.

Other types of attachment structures can also be formed on the oil retaining plate, via which the oil retaining plate can be secured on the planetary gear carrier. These attachment structures can be designed as locking clips, which engage with corresponding complementary geometries of the planetary gear carrier. For example, in the region of the outer edge of the plate, clamp structures can be formed which are able to lock to the planetary gear carrier by a positive-fit connection.

Passages, for example, bore holes having a cylindrical cross-section, can be formed on the oil retaining plate in an advantageous manner, for the purpose of accommodating attachment means, where the passages are sized in such a manner that the attachment means acquire lateral play in the passages. In this way, it is possible for the oil retaining plate to initially bear substantially no tension via the channel pins, and to be attached to the planetary gear carrier while self-centering. The oil retaining plate can then be tightened via the attachment means without applying radial forces to the planetary gear carrier. These attachment means can be designed as rivets, for example, as rivet sleeves. The application of the tightening forces by means of these attachment means is realized over a large surface area as a result of accordingly sized head contact surfaces of the attachment means, or by washers. It is possible for the oil retaining plate to be designed with a greater thickness around the zones where the attachment means will be accommodated.

Holding structures can also be designed on the annular body, providing the attachment means in turn with a loss-proof retainer. As such, it is possible to construct a snap-on edge structure in the space intended to accommodate the attachment means, where the head region of the attachment means is inserted into the snap-on edge structure in such a manner that the attachment means not only secures the oil retaining plate, but is also held on the oil retaining plate in the unlikely event of loosening as a result of operation.

The oil retaining plate is made as an injection molded plastic component, for example. Any undercuts, which may be required to implement a locking geometry, are shaped in such a manner that they can be released via short sliding paths. The concept according to the invention fundamentally enables the manufacture of the oil retaining plate with no undercuts, such that a corresponding mold tool can be opened and closed by axial displacement of the halves of the mold.

The invention is also suited for the manufacture of the oil retaining plate as a molded sheet metal part. The circular recess, which is initially open on one side and is only bounded laterally by the planetary gear carrier once installed, can be manufactured by a corresponding press stamp.

It is also possible to manufacture the oil retaining plate as a composite material component, for example, as a metal/plastic composite part. To this end, the annular body can be made from a sheet metal material, by way of example, where the circular recess and also the channel pins which dip into the planetary gear axle bolts are injection molded onto the sheet metal material. The injection molded plastic structure can allow the realization of filigree geometries which lead to a relatively tight seat of the oil retaining plate on the end face of the planetary gear carrier, by way of example.

### BRIEF DESCRIPTION OF THE DRAWINGS

Additional details and features of the invention are found in the following description in connection with the drawings, in which:

FIG. 1 shows a perspective illustration of an oil retaining plate of the present invention, connected to a planetary gear carrier;

FIG. 2 shows a perspective illustration of the oil retaining plate of FIG. 1 with a view of the rear or inner side used to form the oil feed recess;

FIG. 3a shows an axial cutaway illustration to present the cross-section of the oil retaining plate of the invention when installed; and,

FIG. 3b shows a detailed illustration to present the attachment of the oil retaining plate of the invention on the planetary gear carrier.

### DETAILED DESCRIPTION OF THE INVENTION

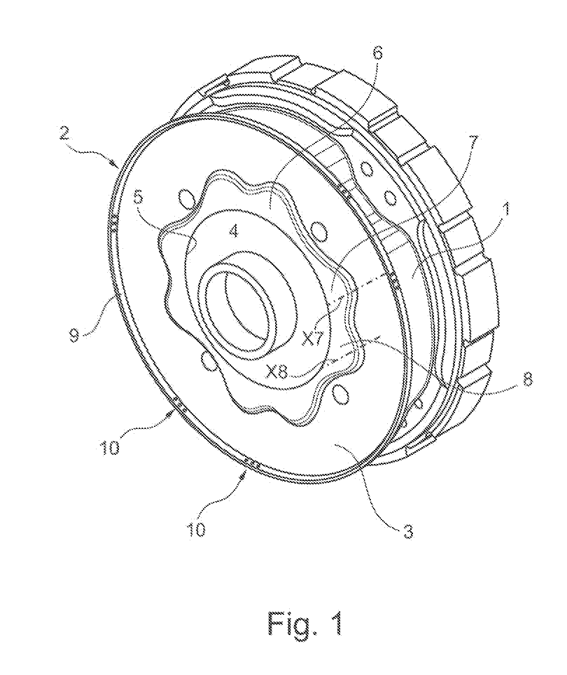

FIG. 1 shows an oil retaining plate of the present invention, which is connected as such to planetary gear carrier 1 in order to adequately supply the bearing points of the planetary gears—the same disposed in the interior of planetary gear carrier 1 and not explicitly recognizable in this drawing—with oil.

The oil retaining plate has an annular body with outer edge 2 and seat 3 via which the annular body sits on the end face of planetary gear carrier 1. The oil retaining plate forms central opening 4, which is bounded by inner edge 5. The oil retaining plate also forms circular recess 6, which extends around a circular region running around central opening 4 between seat 3 and inner edge 5, and rises axially past the end face of planetary gear carrier 1, forming an access slot which runs between inner edge 5 and planetary gear carrier 1 for the purpose of capturing lubricant, which moves as such into the region of central opening 4.

Circular recess 6 has recess segments 7, 8 in its base area, the base area facing away from central opening 4 and being adjacent to seat 3, and recess segments 7, 8 are open toward planetary gear carrier 1, are arranged sequentially about the periphery, bulge outward radially, and extend from each inner edge 5, which bounds central opening 4 outward radially until the radial distance of planetary gear axes X7, X8 of planetary gear carrier 1.

Circular recess 6 is bounded on one side by the annular body and on the other side directly by the end face of planetary gear carrier 1. Circular recess 6 is therefore positioned with its lateral region, which faces planetary gear carrier 1 open to the planetary gear carrier 1—i.e., it is not separated from the same by a further wall. This makes it possible to manufacture the circular recess using a tool—for example, a cropped mold section which can be lifted off of the resulting component axially.

The base body is sized in such a manner that outer edge 2 rises past the shell diameter of the planetary gears carried by planetary gear carrier 1. Edge walling 9 runs along outer edge 2 and transitions into the substantially flat region of the base body, which includes seat 3, via a rounded transition region.

In the embodiment shown, edge walling 9 runs continuously along a circular path which is concentric to the axis of rotation of planetary gear carrier 1. Multiple channel holes 10 are molded into edge walling 9. Channel holes 10, in this case, are grouped into groups of three. There are larger angular distances between these triplets than between channel holes 10 within a triplet. The channel holes are sized in such a manner that they fill when dipped into the oil pan because of capillary action, and carry the captured oil out of the oil pan until it is centrifuged out by means of centrifugal force.

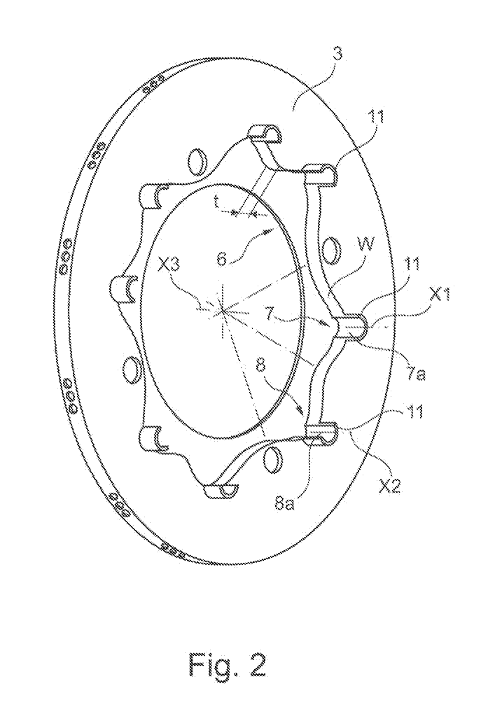

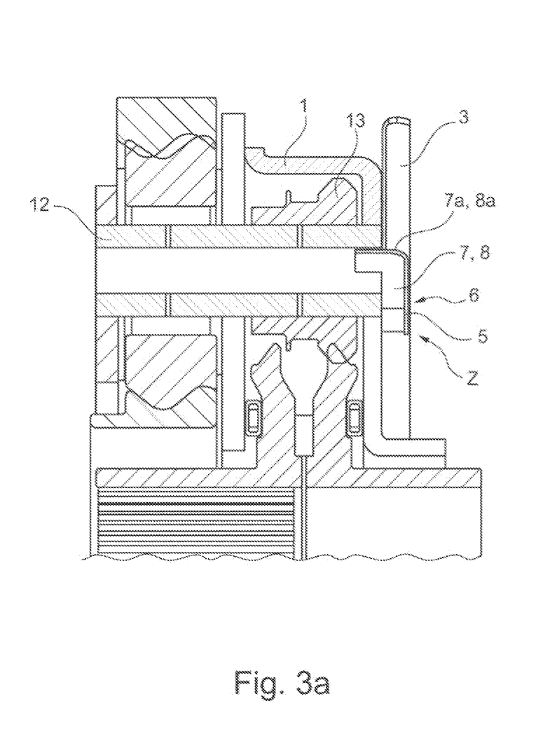

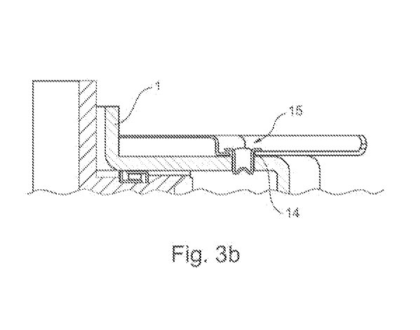

FIG. 2, channel pins 11 are molded onto the annular body in the region of the recess segments 7, 8. The channel pins 11 project axially beyond seat 3 of the base body, and when installed (cf. FIG. 3) dip into the bearing pins of the planetary gears. The variant shown serves the function of supplying lubricant to a multi-component spur gear differential. The oil retaining recess shown, which has radial, alternating bulges in the profile thereof running around the periphery, is only formed—in contrast to the configurations above—once it is connected to the planetary gear carrier, meaning the differential cage. The structure can be removed from the mold axially. The frontal structure of the oil retaining plate enables the collection of oil at the positions of axes X1, X2 of the planetary gear pins because of centrifugal force.

Depth t of circular recess 6, as measured in the axial direction of axis of rotation X3 of the oil retaining plate, is relatively small, and corresponds in the embodiment shown to approximately half of the diameter of the bore holes of the planetary gear bearing pins, the bore holes included for the purpose of receiving the channel pins. The recess segments 7, 8 are bounded at their furthest radial extent by base wall W, the same running in “radial waves.” This base wall forms a collection zone for each recess segment 7, 8, the collection zone opening into inner groove 7a, 8a of corresponding channel pin 11. Wave-profiled base wall W forms convex, inwardly bulging transitional waves between each channel pin 11. The wave troughs, which are concave with respect to the interior space of the recess segment, and which are positioned between the transitional waves, open into inner grooves 7a, 8a of the channel pins. The embodiment shown serves the function of supplying lubricant in a multi-component spur gear differential, in such a planetary gearing, the distance between axes X1, X2 of the planetary gears of a pair of spur gears is less than the distance between the axis of one planetary gear and the axis of the neighboring planetary gear of the neighboring spur gear pair. The wall region, peripheral walling W of which as such bridges the greater distance between sequential channel grooves 11, here bulges out farther toward axis of rotation X3 than the segment of peripheral walling W which extends between two more closely adjacent channel grooves 11. The wave crests of the “short waves” defined by peripheral walling W bulge farther outward than the wave crests of the “long waves.”

The construction of a planetary drive which functions as a differential gear is illustrated in FIG. 3a. Planetary gear pins 12 are anchored in planetary gear carrier 1. One planetary gear 13 is mounted on each of these planetary gear pins 12. The planetary gear carrier is made as a thick-walled deep-drawn part, and forms a bell which encloses the internal mechanism of the planetary gear box. The supply of lubricant to the bearing points of planetary gears 13 is realized by feeding lubricant into the inner region of planetary gear pins 12. This feeding of lubricant is accomplished by means of the oil retaining plate designed according to the invention. The oil retaining plate sits on an end face of planetary gear carrier 1, by its seat surface 3.

Channel pins 11 named above are constructed on the inner side of the oil retaining plate. These channel pins 11 dip into central bore hole 12a of planetary gear pin 12, and thus, guide the oil captured in each recess segment 7, 8 into central bore hole 12a. Recess segments 7, 8 have recess base zones 7a, 8a, which bulge outward radially. Circular recess 6, which includes recess segments 7, 8, is open to planetary gear carrier 1 on the side region which faces planetary gear carrier 1, and is therefore bounded by planetary gear carrier 1 itself.

Circular recess 6 extends around the central opening in an annular region between seat 3 and inner edge 5. The walling, which bounds circular recess 6 at the front rises axially past seat 3 to form access slot Z which runs between inner edge 5 and planetary gear carrier 1. Access slot Z enables the capture of lubricant, which as such travels into the region of the central opening. In the embodiment shown, the oil retaining plate is made of a plastic material.

In FIG. 3b, passages 14 are configured in the oil retaining plate for the purpose of receiving attachment means 15. Passages 14 are sized in such a manner that attachment means 15 acquire lateral play in passages 14, and therefore do not convey radial stresses into the oil retaining plate. Attachment means 15 in this case are designed as bushings. The outer diameter of these bushings is smaller than the corresponding passage 14. As such, the oil retaining plate can “swim” into the configuration, and center itself on planetary gear carrier 1 substantially without tension.

What is claimed is:

1-10. (canceled)

11. An oil retaining plate to be placed on a planetary gear carrier, comprising:
an annular body with an outer edge;
a seat via which the annular body sits on an end face of the planetary gear carrier;
a central opening which is bordered by an inner edge; and,
a circular recess which extends around the central opening along a circular region between the seat and the inner edge, and which rises past the seat of the planetary gear carrier axially to form an access slot which runs between the inner edge and the planetary gear carrier, to capture lubricant which as such travels to the region of the central opening, wherein the circular recess has recess segments which bulge outward radially and which extend outward from the inner edge which borders the central opening, as far as the radial distance of the planetary gear axles of the planetary gear carrier, wherein said recess segments are arranged sequentially along the periphery of the base area of the circular recess, said base area facing away from the central opening and abutting the seat, and wherein the circular recess, in the lateral region thereof which faces the planetary gear carrier, is open to the planetary gear carrier and is accordingly bounded by the planetary gear carrier itself.

12. An oil retaining plate as recited in claim 11, wherein the base body is sized in such a manner that the outer edge rises past the shell diameter of the planetary gears carried by the planetary gear carrier.

13. An oil retaining plate as recited in claim 12, wherein an edge walling is formed along the outer edge.

14. An oil retaining plate as recited in claim 13, wherein the edge walling extends continuously along the outer edge.

15. An oil retaining plate as recited in claim 14, wherein channel holes are formed into the edge walling.

16. An oil retaining plate as recited in claim 11, wherein channel pins are formed in the region of the recess segments, and project axially past the seat of the base body, dipping into the bearing pins of the planetary gears when assembled.

17. An oil retaining plate as recited in claim 11, wherein passages are configured in the oil retaining plate for the purpose of receiving attachment means, wherein the passages are sized in such a manner that the attachment means acquire lateral play in the passages.

18. An oil retaining plate as recited in claim 11, wherein the oil retaining plate is made of a plastic material.

19. An oil retaining plate as recited in claim 11, wherein the oil retaining plate is designed as a molded sheet metal part.

20. An oil retaining plate as recited in claim 11, wherein the same is configured with locking structures, and when assembled is secured on the planetary gear carrier via these locking structures.
